(19) United States
(12) Patent Application Publication
(10) Pub. No.: US 2020/0026022 A1
(43) Pub. Date: Jan. 23, 2020

(54) Lens Device

(71) Applicants: Sintai Optical (Shenzhen) Co., Ltd., ShenZhen City (CN); Asia Optical Co., Inc., Taichung (TW)

(72) Inventor: Guo-Quan Lin, ShenZhen City (CN)

(21) Appl. No.: 16/429,289

(22) Filed: Jun. 3, 2019

(30) Foreign Application Priority Data
Jul. 20, 2018 (CN) 201821165700.6

(51) Int. Cl. G02B 7/02

(52) U.S. Cl. CPC G02B 7/021

(57) ABSTRACT

A lens device includes a lens barrel and a plurality of lenses, wherein the lens closest to the objective side is a first lens. The first lens includes a first optical effective portion and a first peripheral portion. The first optical effective portion includes a first surface, an extending surface extending along the optical axis and a second surface connected to the extending surface, the first peripheral portion surrounds the first surface, and a height difference is formed between the first optical effective portion and the first peripheral portion. A junction of the extending surface and an objective-side surface of the first peripheral portion is not in contact with the lens barrel, and a contact surface of the first peripheral portion contacting the lens barrel is not perpendicular to the optical axis.

### BACKGROUND OF THE INVENTION

### Field of the Invention

The invention relates to a lens device.

### Description of the Related Art

FIG. 1 depicts a sectional view of a prior lens device 100. As shown in FIG. 1, the lens device 100 includes a lens barrel 106, a first lens 101, a second lens 102, a third lens 103, a fourth lens 104 and a fifth lens 105, wherein the first lens 101, the second lens 102, the third lens 103, the fourth lens 104 and the fifth lens 105 are sequentially disposed in the lens barrel 106 from an objective side to an image side along an optical axis. The lens barrel 106 is provided with a plurality of stepped bearing surfaces for supporting lenses. The first lens 101 is closest to the objective side and includes an optical effective portion 101a and a peripheral portion 101b surrounding the optical effective portion 101a, and the peripheral portion 101b is placed against the stepped bearing surface 106a and fixed in the lens barrel 106.

In the above described lens device 100, the first lens 101 is contained in the lens barrel 106, and a highest point of the optical effective portion 101a is lower than an end surface of the lens barrel 106 facing the objective side. A defect of the lens device 100 is that the first lens 101 occupies quite a space in the lens barrel 106 and the visual angle of the lens device 100 is limited.

### BRIEF SUMMARY OF THE INVENTION

For solving the problem of the above-described lens device in which the first lens occupies quite a space in the lens barrel and the visual angle of the lens device is limited, the invention provides a lens device in which a space occupied by a lens closest to an objective side is reduced, and a visual angle thereof is wide.

A lens device in accordance with an embodiment of the invention includes a lens barrel and a plurality of lenses. The lenses are sequentially fixed in the lens barrel from an objective side to an image side along an optical axis, wherein one of the lenses closest to the objective side is a first lens. The first lens includes a first optical effective portion and a first peripheral portion. The first optical effective portion includes a first surface, an extending surface extending along the optical axis and a second surface connected to the extending surface, the first peripheral portion surrounds the first surface, and a height difference is formed between the first optical effective portion and the first peripheral portion. A junction of the extending surface and an objective-side surface of the first peripheral portion is not in contact with the lens barrel, and a contact surface of the first peripheral portion contacting the lens barrel is not perpendicular to the optical axis.

In another embodiment, the first surface faces the image side and the second surface faces the objective side, a section of the first lens along the optical axis is higher at the middle and lower at both left and right ends, and the section of the first lens includes a first angled corner with a first internal angle ranged from 90 to 130 degrees, a second angled corner with a second internal angle ranged from 225 to 270 degrees, and a rounded corner with a third internal angle ranged from 90 to 120 degrees, wherein the first angled corner, the second angled corner and the rounded corner are arranged from a center portion of the first lens to a periphery portion of the first lens.

In yet another embodiment, the first optical effective portion protrudes along the optical axis towards the objective side.

In another embodiment, the objective-side surface extends in a radial direction of the first lens, and the extending surface is substantially parallel to the optical axis.

In yet another embodiment, the lens barrel is provided with a first lens fixing hole, and the first lens is fixed in the first lens fixing hole through the first peripheral portion.

In another embodiment, an external diameter of the first peripheral portion equals or is smaller than an internal diameter of the first lens fixing hole, the first peripheral portion is fixed in the first lens fixing hole, and a chamfer is formed on an end surface of the lens barrel facing the objective side and surrounds the first lens fixing hole.

In yet another embodiment, the first optical effective portion protrudes from the first lens fixing hole.

In yet another embodiment, the lens barrel has a second lens bearing surface, a thickness of the first peripheral portion of the first lens along the optical axis is greater than a distance between the end surface of the lens barrel facing the objective side and the second lens bearing surface, and the second lens is placed against the first lens.

In another embodiment, the lens barrel has a second lens bearing surface, a thickness of the first peripheral portion of the first lens along the optical axis equals or is smaller than a distance between the end surface of the lens barrel facing the objective side and the second lens bearing surface, and the second lens is placed against the second lens bearing surface.

In yet another embodiment, the lens device further includes a cover disposed on an objective end of the lens barrel, wherein the cover comprises a main body and a flange extending from the main body towards the image side, and the main body of the cover is provided with a hole allowing the first optical effective portion of the first lens to protrude.

In another embodiment, the objective-side surface of the first peripheral portion is aligned with the end surface of the lens barrel facing the objective side.

In yet another embodiment, the end surface of the lens barrel facing the objective side comprises a plurality of end surfaces arranged to be stepped, and one of the end surfaces farthest away from the optical axis is closest to the objective side.

In another embodiment, the lens device further includes a dish-like cover, wherein the dish-like cover comprises a cylindrical wall surrounding the extending surface of the first lens and a plate extending from an end of the cylindrical wall facing the image side in a direction perpendicular to the optical axis.

In yet another embodiment, the cylindrical wall of the dish-like cover is provided with a hole configured to expose the first optical effective portion of the first lens, and a diameter of the hole equals or is slightly greater than an external diameter of the extending surface of the first optical effective portion.

In another embodiment, the hole of the cylindrical wall has varying diameters, one of which measured closest to the objective side substantially equals an aperture diameter of the lens device, and the hole of the cylindrical wall is located where an aperture of the lens device is.

In yet another embodiment, the end surface of the lens barrel facing the objective sides is stepped and comprises a first end surface, a second end surface and a third end surface, the first end surface, the second end surface and the third end surface are sequentially arranged from outer to inner of the lens barrel. The first end surface is closest to the objective side, the third end surface is closest to the image side, and the second end surface is arranged between the first end surface and the third end surface.

In another embodiment, a size of the dish-like cover corresponds to a size of an objective end of the lens barrel. When the dish-like cover and the lens barrel are assembled, an outer edge of the dish-like cover has a contact with the lens barrel at a location where the height difference between the first end surface and the second end surface is formed, and the plate fully covers the second end surface.

In yet another embodiment, the third end surface is configured for applying glue thereto, and the dish-like cover covers the second end surface so as to be connected to the lens barrel.

The lens device of the invention provides following benefits: the first optical effective portion of the first lens closest to the objective side protrudes from the first lens fixing hole so as to obtain a wide visual angle; and the first lens is fixed in the first lens fixing hole through the first peripheral portion thereof so that the space in the lens barrel occupied by the first lens is reduced.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a sectional view of a prior lens device;

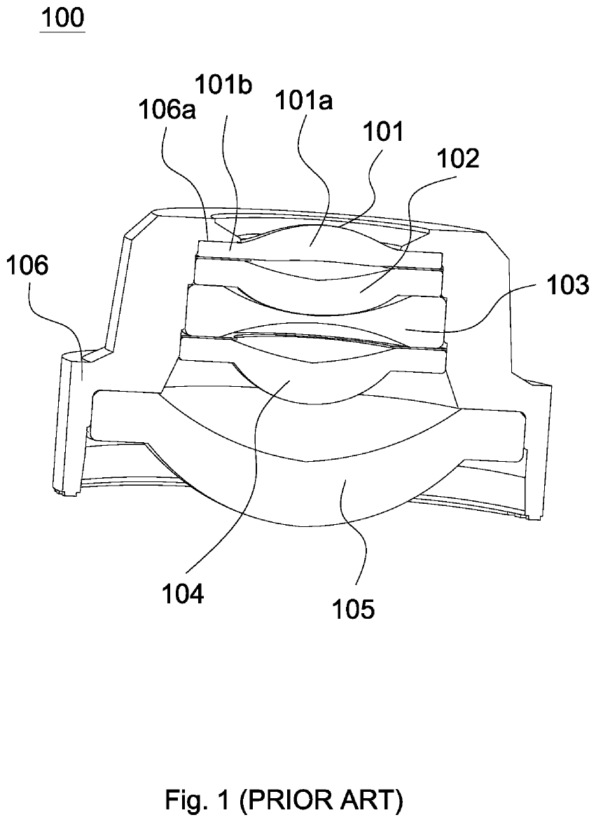

FIG. 2A is an exploded view of a lens device in accordance with a first embodiment of the invention;

FIG. 2B depicts the left half of a sectional of a first lens of FIG. 2A;

FIG. 3 is a schematic view of the lens device in accordance with the first embodiment of the invention;

FIG. 4 is an exploded view of a lens device in accordance with a second embodiment of the invention;

FIG. 5 is a schematic view of the lens device in accordance with the second embodiment of the invention;

FIG. 6 is an exploded view of a lens device in accordance with a third embodiment of the invention;

FIG. 7 is a schematic view of the lens device in accordance with the third embodiment of the invention;

FIG. 8 is an exploded view of a lens device in accordance with a fourth embodiment of the invention;

FIG. 9 is a schematic view of the lens device in accordance with the fourth embodiment of the invention;

FIG. 10 is an exploded view of a lens device in accordance with a fifth embodiment of the invention;

FIG. 11 is a schematic view of the lens device in accordance with the fifth embodiment of the invention.

### DETAILED DESCRIPTION OF THE INVENTION

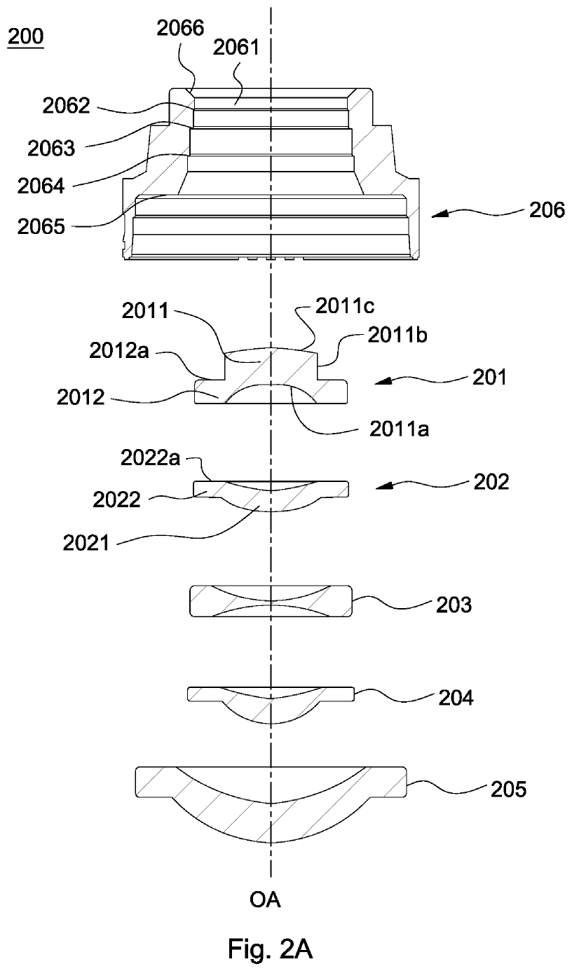

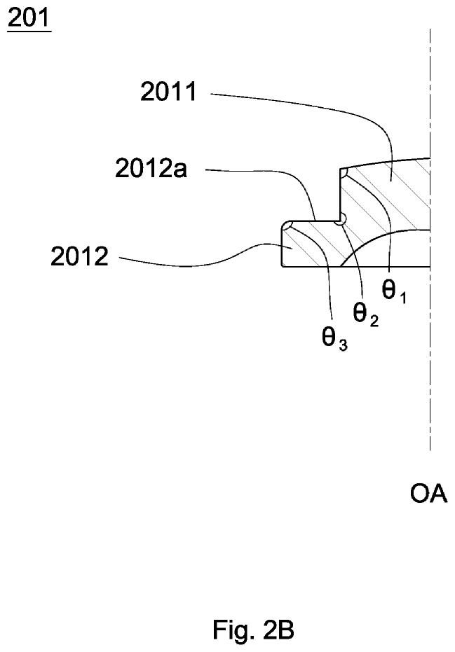

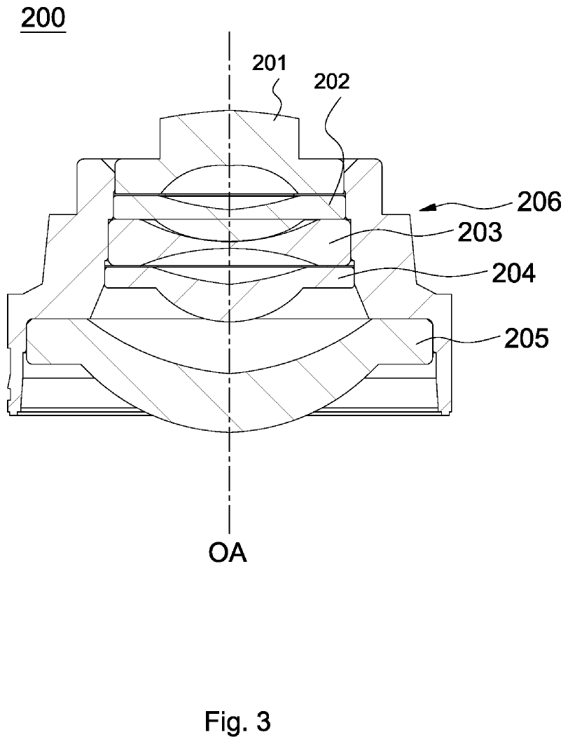

Referring to FIGS. 2A-3, a lens device 200 in accordance with a first embodiment of the invention includes a lens barrel 206 and a plurality of lenses sequentially fixed in the lens barrel 206 from an objective side to an image side along an optical axis OA. In the first embodiment, the quantity of the lenses is five. In other words, the lenses are a first lens 201, a second lens 202, a third lens 203, a fourth lens 204 and a fifth lens 205. However, the invention is not limited to that. The quantity of the lenses can be two, three, six or other number. Among the lenses of the lens device, the first lens 201 is closest to the objective side.

A section of the first lens 201 along the optical axis OA is “ [symbol] ”-shaped. In other words, the section of the first lens 201 is higher at the middle (where the optical axis OA passes) and lower at both left and right ends. As shown in FIG. 2B, the left half of the section of the first lens 201 with respect to the optical axis OA has at least three successive corners, wherein a first angled corner has a first internal angle θ₁ ranged from 90 to 130 degrees, a second angled corner has a second internal angle θ₂ ranged from 225 to 270 degrees, and a rounded corner has a third internal angle θ₃ ranged from 90 to 120 degrees, and the first angled corner, the second angled corner and the rounded corner are arranged from a center portion of the first lens 201 to a periphery portion of the first lens 201. The right half of the section of the first lens 201 is symmetrical to the left half of the section of the first lens 201 with respect to the optical axis OA, and therefore the descriptions thereof are omitted. The first lens 201 includes a first optical effective portion 2011 and a first peripheral portion 2012 surrounding the first optical effective portion 2011. The first peripheral portion 2012 extends in a direction perpendicular to the optical axis OA so as to form a maximum external diameter of the first lens 201. The first optical effective portion 2011 protrudes along the optical axis OA towards the objective side and includes a first surface 2011a facing the image side, an extending surface 2011b extending along the optical axis OA and a second surface 2011c facing the objective side and connected to the extending surface 2011b. The first peripheral portion 2012 surrounds the first surface 2011a rather than the extending surface 2011b. At least one surface selected from the first surface 2011a and the second surface 2011c is curved surface. In such arrangement, a height difference is formed between the first optical effective portion 2011 and the first peripheral portion 2012.

The second surface 2011c, the extending surface 2011b and the first peripheral portion 2012 are sequentially arranged from the objective side to the image side along the optical axis OA. A section of the first lens 201 is shown in FIGS. 2A and 3 wherein the extending surface 2011b and a surface 2012a of the first peripheral portion 2012 facing the objective side (that is, an objective-side surface of the first peripheral portion 2012) form an L-shaped surface. In other words, the surface 2012a of the first peripheral portion 2012 facing the objective side extends in a radial direction of the first lens 201, the extending surface 2011b is substantially parallel to the optical axis OA, and the extending surface 2011b is substantially perpendicular to the surface 2012a. Further, the extending surface 2011b is cylindrical and has a radius. However, the actual radius of the extending surface 2011b of the first lens 201 may have a deviation from the nominal radius thereof. In the first embodiment, the deviation of the actual radius from the nominal radius is ±0.01 mm. When the first lens 201 is disposed in the lens barrel 206, the L-shaped surface is not in contact with the lens barrel 206. Preferably, the surface 2012a of the first peripheral portion 2012 facing the objective side is aligned with an end surface of the lens barrel 206 facing the objective surface. However, the invention is not limited to that. The surface 2012a of the first peripheral portion 2012 facing the objective side can protrude from the end surface of the lens barrel 206 facing the objective surface.

The second lens 202 includes a second optical effective portion 2021 and a second peripheral portion 2022 surrounding the second optical effective portion 2021, and the second peripheral portion 2022 extends in the direction perpendicular to the optical axis OA. A surface 2022a of the second peripheral portion 2022 facing the objective side is a bearing surface that is perpendicular to the optical axis OA.

The lens barrel 206 has a plurality of bearing surfaces arranged to be stepped. In other words, the lens barrel 206 has a second lens bearing surface 2062, a third lens bearing surface 2063, a fourth lens bearing surface 2064 and a fifth lens bearing surface 2065. The lens barrel 206 is provided with a first lens fixing hole 2061. On the end surface of the lens barrel 206 facing the objective side, a chamfer is provided and surrounds the first lens fixing hole 2061 so as to form a gluing hole 2066. The first lens 201 is disposed in the first lens fixing hole 2061 through the first peripheral portion 2012 and is fixed by gluing. An external diameter of the first peripheral portion 2012 equals or is slightly smaller than an internal diameter of the first lens fixing hole 2061. When applied to the gluing hole 2066, glue passes into a narrow space between the first lens fixing hole 2061 and the first peripheral portion 2012 by capillarity so that the first lens fixing hole 2061 and the first lens 201 are glued together. Surfaces of the first peripheral portion 2012 contacting the lens barrel 206 are not perpendicular to the optical axis OA. The first lens 201 is not in contact with any of the second lens bearing surface 2062, the third lens bearing surface 2063, the fourth lens bearing surface 2064 and the fifth lens bearing surface 2065.

The first optical effective portion 2011 protrudes from the first lens fixing hole 2061. That is, the second surface 2011c facing the objective side and the extending surface 2011b extending along the optical axis OA is outside the lens barrel 206. Preferably, the surface 2012a of the first peripheral portion 2012 facing the objective side is aligned with an end surface of the lens barrel 206 facing the objective surface.

During the assembly, the first lens 201 is sucked by a sucking disk, and the sucking disk is then moved into the lens barrel 206 towards the objective side. After the first lens 201 is placed at a predetermined position, the first lens 201 is fixed by gluing, and the sucking disk is removed. Then, the second lens 202, the third lens 203, the fourth lens and the fifth lens 205 are sequentially assembled.

In the first embodiment, a thickness of the first peripheral portion 2012 of the first lens 201 along the optical axis OA is greater than a distance between the end surface of the lens barrel 206 facing the objective side and second lens bearing surface 2062. In such arrangement, the second lens 202 is placed against the first lens 201 and is not placed against the second lens bearing surface 2062.

In the first embodiment, the third lens 203 is placed against the third lens bearing surface 2063, the fourth lens 204 is placed against the third lens 203, and the fifth lens 205 is placed against the fifth lens bearing surface 2065. However, the invention is not limited thereto.

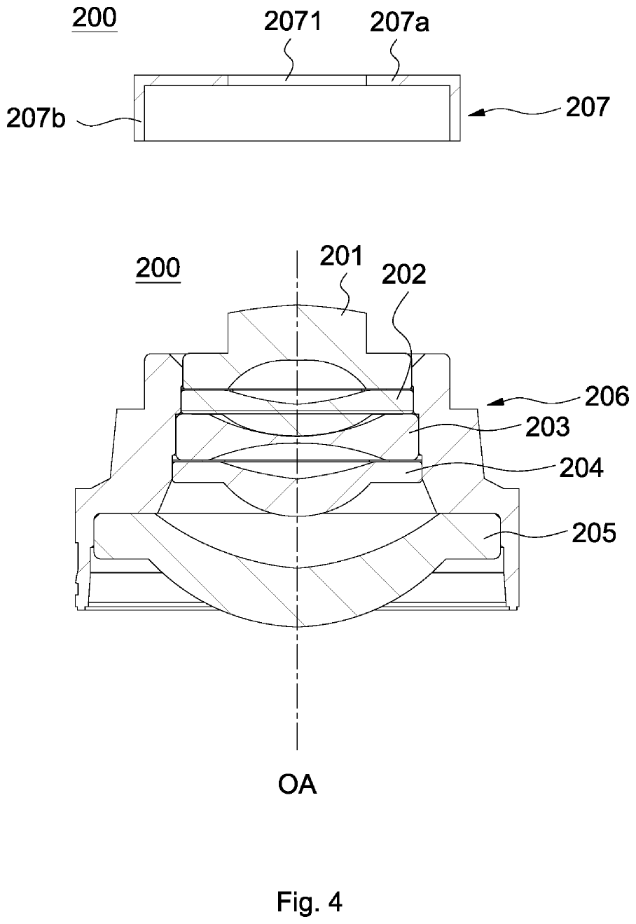

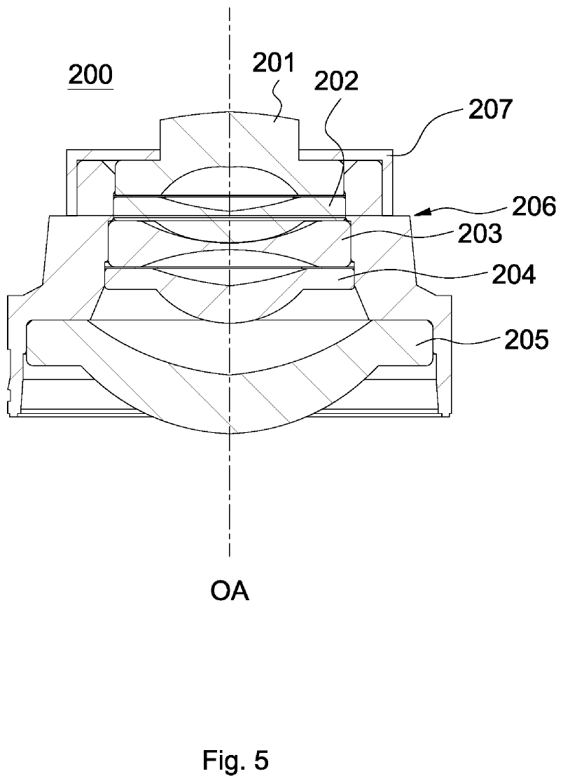

FIGS. 4-5 depict a lens device 200 in accordance with a second embodiment of the invention. The descriptions of the second embodiment similar to those of the first embodiment are omitted. The difference between the first and second embodiment is that the lens device 200 of the second embodiment further includes a cover 207. The cover 207 includes a main body 207a and a flange 207b extending towards the image side. The main body 207a of the cover 207 is provided with a hole 2071 allowing the first optical effective portion 2011 of the first lens 201 to protrude therefrom. A diameter of the hole 2071 equals or is slightly greater than an external diameter of the extending surface 2011b of the first optical effective portion 2011.

Similar to that of the first embodiment, the extending surface of the first lens 201 of the second embodiment is cylindrical and has a radius. The actual radius of the extending surface of the first lens 201 may have a deviation from the nominal radius thereof. In the second embodiment, the deviation of the actual radius of the extending surface from the nominal radius is smaller than a distance between the cover 207 and the extending surface of the first lens 201.

A size of the cover 207 corresponds to a size of an objective end of the lens barrel 206. When the cover 207 and the lens barrel 206 are assembled, the first lens 201 is firmly fixed by the cover 207 and is prevented from dropping. The person having ordinary skill in the art can understand that the cover 207 is not necessary.

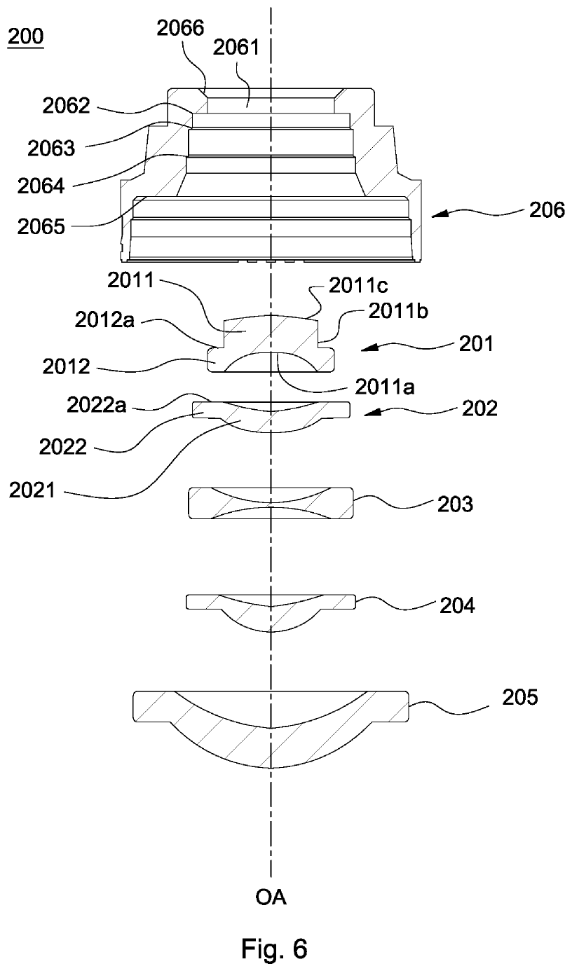

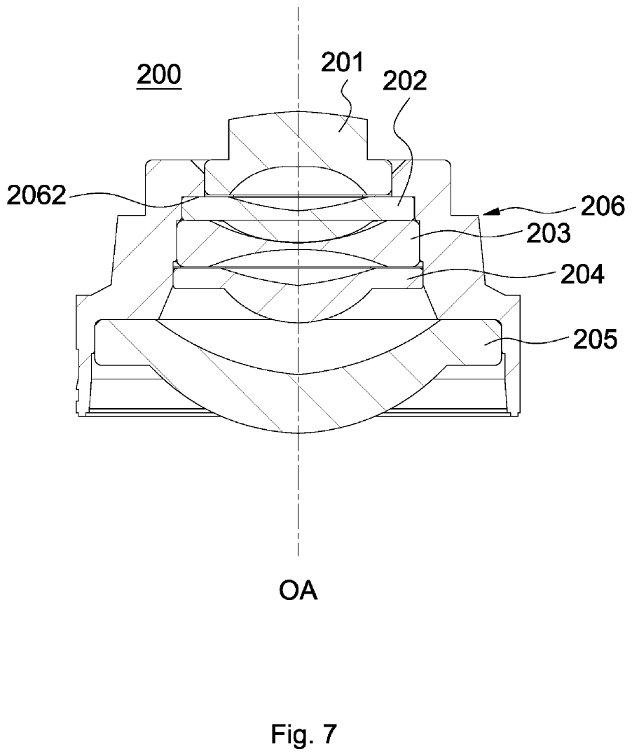

FIGS. 6-7 depict a lens device 200 in accordance with a third embodiment of the invention. The descriptions of the third embodiment similar to those of the first embodiment are omitted. The difference between the first and third embodiment is that a thickness of the first peripheral portion 2012 of the first lens 201 along the optical axis OA equals or is smaller than a distance between the end surface of the lens barrel 206 facing the objective side and second lens bearing surface 2062. When the second lens 202 is disposed in the lens barrel 206, the second lens 202 is placed against the second lens bearing surface 2062. Such arrangement allows a space provided between the first lens 201 and the second lens 202.

In the third embodiment, the third lens 203 is placed against the third lens bearing surface 2063, the fourth lens 204 is placed against the third lens 203, and the fifth lens 205 is placed against the fifth lens bearing surface 2065. However, the invention is not limited thereto.

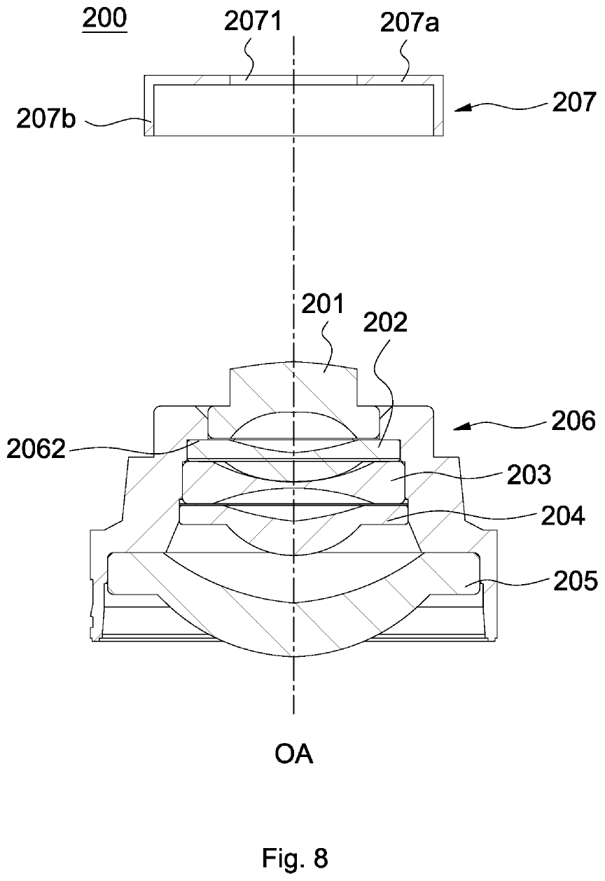

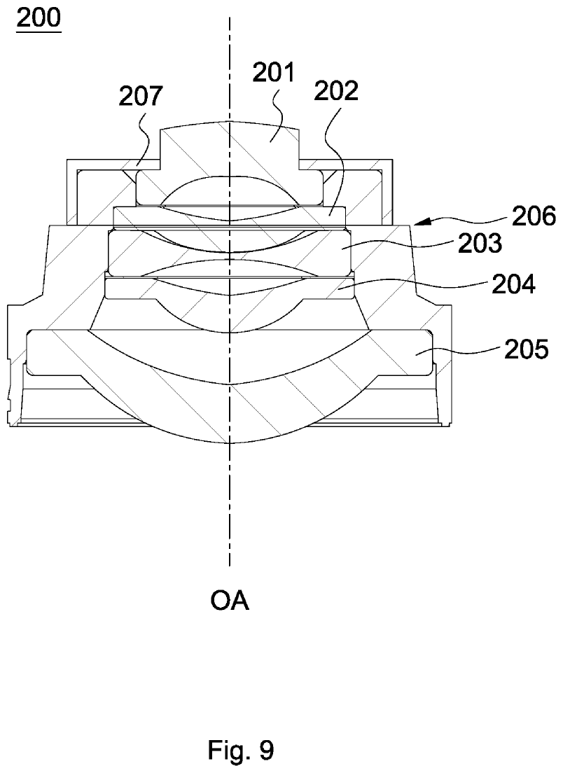

FIGS. 8-9 depict a lens device 200 in accordance with a fourth embodiment of the invention. The fourth embodiment is obtained by modifying the third embodiment, and the descriptions of the fourth embodiment similar to those of the third embodiment are omitted. In the fourth embodiment, the lens device 200 further includes a cover 207. The structure of the cover 207 and the relationship between the first lens 201, the lens barrel 206 and the cover 207 are similar to those of the second embodiment, and therefore the descriptions thereof are omitted.

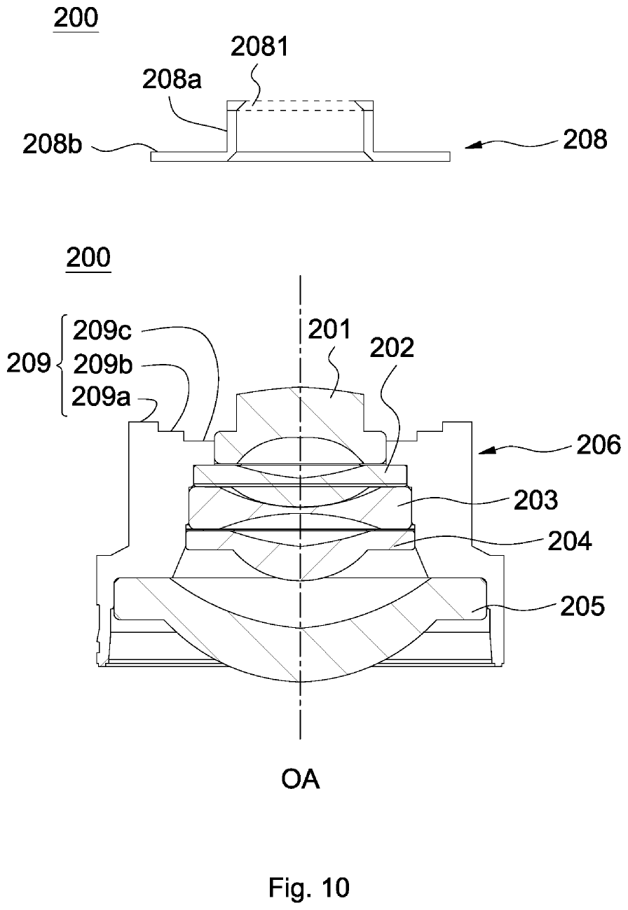

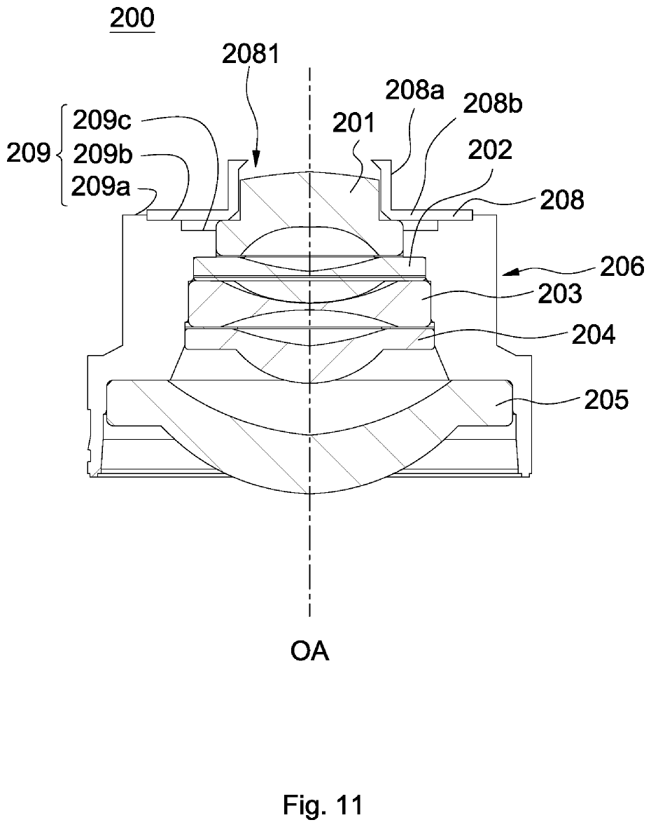

FIGS. 10-11 depict a lens device 200 in accordance with a fifth embodiment of the invention. The descriptions of the fifth embodiment similar to those of the first embodiment are omitted. The difference between the first and fifth embodiment is that the lens device 200 of the fifth embodiment further includes a dish-like cover 208. The dish-like cover 208 includes a cylindrical wall 208a configured to surround the extending surface 2011b and a plate 208b extending from an image side of the cylindrical wall 208a in the direction perpendicular to the optical axis OA. The cylindrical wall 208a of the dish-like cover 208 is provided with a hole 2081 configured to expose the first optical effective portion 2011 of the first lens 201. A diameter of the hole 2081 equals or is slightly greater than an external diameter of the extending surface 2011b of the first optical effective portion 2011. In the fifth embodiment, the cross section of the hole 2081 is non-uniform and therefore the hole 2081 has varying diameters. A diameter of the hole 2081 measured closest to the objective side substantially equals an aperture diameter of the lens device 200. Further, the hole 2081 is located where the aperture of the lens device 200 is.

Another difference between the first and fifth embodiment is that an end surface 209 of the lens barrel 206 facing the objective side is stepped and includes a first end surface 209a, a second end surface 209b and a third end surface 209c. The first end surface 209a, the second end surface 209b and the third end surface 209c are sequentially arranged from outer to inner of the lens barrel 206. The first end surface 209a is closest to the objective side, the third end surface 209c is closest to the image side, and the second end surface 209b is arranged between the first end surface 209a and the third end surface 209c. However, the quantity of the end surfaces arranged to be stepped is not limited to three. That is, the quantity of the end surfaces can be two or more than three. In addition, the third end surface 209c can be closer to the objective side than the second end surface 209b, and the first end surface 209a is still closest to the objective side.

A size of the dish-like cover 208 corresponds to a size of an objective end of the lens barrel 206. When the dish-like cover 208 and the lens barrel 206 are assembled, an outer edge of the plate 208b of the dish-like cover 208 has a contact with the lens barrel 206 at a location where a height difference is formed between the first end surface 209a and the second end surface 209b, and the plate 208b fully covers the second end surface 209b. The third end surface 209c is configured for applying glue thereto. During the assembly, the glue is applied to the third end surface 209c, and the dish-like cover 208 covers the second end surface 209b so that the dish-like cover 208 is connected to the lens barrel 206. The dish-like cover 208 can be firmly fixed to the first lens 201 so that the first lens 201 is prevented from dropping. The person having ordinary skill in the art can understand that the dish-like cover 208 is not necessary.

In the above described embodiments, the first lens 201, the second lens 202, the third lens 203, the fourth lens 204 and/or the fifth lens 205 is glass or plastic lens.

In the structure of the first lens 201 of the invention, a height difference is formed between the first optical effective portion 2011 and the first peripheral portion 2012. The first optical effective portion 2011 is outside the first lens fixing hole 2061 so as to obtain wide visual angle. The first lens 201 is disposed in the first lens fixing hole 2061 through the first peripheral portion 2012 thereof so that a space in the lens barrel 206 occupied by the first lens 201 is reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A lens device, comprising:
A lens barrel; and
a plurality of lenses sequentially fixed in the lens barrel from an objective side to an image side along an optical axis, wherein one of the lenses closest to the objective side is a first lens;
wherein the first lens comprises a first optical effective portion and a first peripheral portion;
wherein the first optical effective portion comprises a first surface, an extending surface extending along the optical axis and a second surface connected to the extending surface, the first peripheral portion surrounds the first surface, and a height difference is formed between the first optical effective portion and the first peripheral portion;
wherein a junction of the extending surface and an objective-side surface of the first peripheral portion is not in contact with the lens barrel, and a contact surface of the first peripheral portion contacting the lens barrel is not perpendicular to the optical axis.

2. The lens device as claimed in claim 1, wherein the first surface faces the image side and the second surface faces the objective side, a section of the first lens along the optical axis is higher at the middle and lower at both left and right ends, and the section of the first lens comprises a first angled corner with a first internal angle ranged from 90 to 130 degrees, a second angled corner with a second internal angle ranged from 225 to 270 degrees, and a rounded corner with a third internal angle ranged from 90 to 120 degrees, wherein the first angled corner, the second angled corner and the rounded corner are arranged from a center portion of the first lens to a periphery portion of the first lens.

3. The lens device as claimed in claim 1, wherein the first optical effective portion protrudes along the optical axis towards the objective side.

4. The lens device as claimed in claim 3, wherein the objective-side surface extends in a radial direction of the first lens, and the extending surface is parallel to the optical axis.

5. The lens device as claimed in claim 1, wherein the lens barrel is provided with a first lens fixing hole, and the first lens is fixed in the first lens fixing hole through the first peripheral portion.

6. The lens device as claimed in claim 5, wherein an external diameter of the first peripheral portion equals or is smaller than an internal diameter of the first lens fixing hole, the first peripheral portion is fixed in the first lens fixing hole, and a chamfer is formed on an end surface of the lens barrel facing the objective side and surrounds the first lens fixing hole.

7. The lens device as claimed in claim 6, wherein the first optical effective portion protrudes from the first lens fixing hole.

8. The lens device as claimed in claim 1, wherein the lens barrel has a second lens bearing surface, a thickness of the first peripheral portion of the first lens along the optical axis is greater than a distance between the end surface of the lens barrel facing the objective side and the second lens bearing surface, and the second lens is placed against the first lens.

9. The lens device as claimed in claim 8, further comprising a cover disposed on an objective end of the lens barrel, wherein the cover comprises a main body and a flange extending from the main body towards the image side, and the main body of the cover is provided with a hole allowing the first optical effective portion of the first lens to protrude.

10. The lens device as claimed in claim 8, wherein the objective-side surface of the first peripheral portion is aligned with the end surface of the lens barrel facing the objective side.

11. The lens device as claimed in claim 1, wherein the lens barrel has a second lens bearing surface, a thickness of the first peripheral portion of the first lens along the optical axis equals or is smaller than a distance between the end surface of the lens barrel facing the objective side and the second lens bearing surface, and the second lens is placed against the second lens bearing surface.

12. The lens device as claimed in claim 10, further comprising a cover disposed on an objective end of the lens barrel, wherein the cover comprises a main body and a flange extending from the main body towards the image side, and the main body of the cover is provided with a hole allowing the first optical effective portion of the first lens to protrude.

13. The lens device as claimed in claim 10, wherein the objective-side surface of the first peripheral portion is aligned with the end surface of the lens barrel facing the objective side.

14. The lens device as claimed in claim 1, wherein the end surface of the lens barrel facing the objective side comprises a plurality of end surfaces arranged to be stepped, and one of the end surfaces farthest away from the optical axis is closest to the objective side.

15. The lens device as claimed in claim 14, further comprising a dish-like cover, wherein the dish-like cover comprises a cylindrical wall surrounding the extending surface of the first lens and a plate extending from an end of the cylindrical wall facing the image side in a direction perpendicular to the optical axis.

16. The lens device as claimed in claim 15, wherein the cylindrical wall of the dish-like cover is provided with a hole configured to expose the first optical effective portion of the first lens, and a diameter of the hole equals or is slightly greater than an external diameter of the extending surface of the first optical effective portion.

17. The lens device as claimed in claim 16, wherein the hole of the cylindrical wall has varying diameters, one of which measured closest to the device, and the hole of the cylindrical wall is located where an aperture of the lens device is.

18. The lens device as claimed in claim 14, wherein the end surface of the lens barrel facing the objective sides is stepped and comprises a first end surface, a second end surface and a third end surface, the first end surface, the second end surface and the third end surface are sequentially arranged from outer to inner of the lens barrel;
wherein the first end surface is closest to the objective side, the third end surface is closest to the image side, and the second end surface is arranged between the first end surface and the third end surface.

19. The lens device as claimed in claim 18, wherein a size of the dish-like cover corresponds to a size of an objective end of the lens barrel;
wherein when the dish-like cover and the lens barrel are assembled, an outer edge of the dish-like cover has a contact with the lens barrel at a location where the height difference between the first end surface and the second end surface is formed, and the plate fully covers the second end surface.

20. The lens device as claimed in claim 19, wherein the third end surface is configured for applying glue thereto, and the dish-like cover covers the second end surface so as to be connected to the lens barrel.
